(19) United States
(12) Patent Application Publication
(10) Pub. No.: US 2024/0392925 A1
(43) Pub. Date: Nov. 28, 2024

(54) CRYOGENIC LIQUID WITHDRAWAL DEVICE AND SEALING RING

(71) Applicant: TOMCO2 SYSTEMS COMPANY, Loganville, GA (US)

(72) Inventors: RYAN DAHLGREN, Buford, GA (US); JOHN ROMANOS, Mobile, AL (US)

(21) Appl. No.: 18/324,629

(22) Filed: May 26, 2023

(51) Int. Cl. F17C 9/00; F16J 15/02; F17C 13/04; F17C 13/06

(52) U.S. Cl. CPC F17C 9/00; F16J 15/022; F17C 13/04; F17C 13/06; F17C 2205/0311; F17C 2205/0323; F17C 2223/013; F17C 2225/013

(57) ABSTRACT

Examples of the disclosure relate to a liquid withdrawal device useable in conjunction with a cryogenic dewar. A sealing ring may be coupled around an opening of the dewar, and includes a plurality of flanges forming recesses positioned to receive complementary flanges of a head portion of the liquid withdrawal device, forming a twist-and-lock interface.

### BACKGROUND

Cryogenic storage devices, such as dewars, are temperature insulating containers that are often used for cryogenic storage of gases in liquid form. For example, liquid nitrogen may be stored in such a container, and may be used in various medical procedures, such as cryotherapy procedures. Other gases in liquid form may be stored in such a dewar as well. Dewars typically are available in a variety of sizes and geometries, but generally have a wide mouth portion at a top end of the container.

Because of the extremely low temperatures of the liquid gases that are stored in dewars, devices have been developed for dispensing such liquids in a controlled manner. This type of dispensing device, referred to generally as a liquid withdrawal device, may be attached at a wide mouth portion of the dewar, and may include, for example, a dispensing tube and one or more valves.

Existing liquid withdrawal devices typically use a clamp-style mounting arrangement in which the device is installed as a “head” onto the mouth or spout of the dewar. That is, a seal is typically clamped around an upwardly extending portion of the mouth of the dewar. This arrangement has generally proven effective, but is not without drawbacks. For example, the seal formed between the liquid withdrawal device and the dewar mouth, which operates to prevent escape of evaporating gas from within the dewar, is only as effective as the seal formed at the clamp. Furthermore, this clamping arrangement places significant stress on the mouth, or spout portion, of the dewar. Finally, such clamping arrangements are highly dependent on the mouth of the dewar being within a known height and diameter range, to ensure a proper clamping fit between the dewar and liquid withdrawal device.

### SUMMARY

In one aspect, a sealing ring for use in a liquid withdrawal device is disclosed. The sealing ring includes a ring-shaped body forming an interface surface. The sealing ring further includes a plurality of alternating flanges positioned along an outer perimeter of the sealing ring and extending upwardly from the interface surface. Each of the plurality of alternating flanges includes: an outer edge portion extending upwardly from an outer perimeter of the body; a top surface extending axially inwardly from the outer edge portion above the interface surface; and an end wall along one side of the top flange extending from the top flange to the interface surface, thereby forming a flange-receiving recess.

In another example of the above aspect, a liquid withdrawal device is disclosed. The liquid withdrawal device includes a sealing ring and a head portion. The sealing ring includes a ring-shaped body forming an interface surface, and a plurality of alternating flanges positioned along an outer perimeter of the sealing ring and extending upwardly from the interface surface. Each of the plurality of alternating flanges includes an outer edge portion extending upwardly from an outer perimeter of the body, a top surface extending axially inwardly from the outer edge portion above the interface surface, and an end wall along one side of the top flange extending from the top flange to the interface surface, thereby forming a flange-receiving recess. The head portion includes a body including a plurality of flanges extending axially from a bottom portion thereof, one or more valves, and a spout assembly. The head portion and the sealing ring are interconnectable via a twist-and-lock interface.

In another aspect, a liquid withdrawal system includes a sealing ring affixed to a dewar around a mouth of the dewar including a plurality of flanges forming recesses above an interface surface, the flanges and interface surface forming a twist-and-lock interface. The liquid withdrawal system includes a head portion including a body, a plurality of valves, and a spout assembly, the head portion including a plurality of flanges complementary to the recesses formed by the plurality of flanges of the sealing ring.

In further example aspects of the above aspect, a gasket and/or an O-ring seal may be used to establish a seal between the head portion and the sealing ring. In another example, the head portion is configured to lock onto the sealing ring in a twist-and-lock configuration. In a further example, the sealing ring is fixedly adhered to the dewar. For example, the sealing ring is adhered to the dewar via an epoxy adhesive. In yet another example, the liquid is a cryogenic liquid. In still further examples, a locking pin maintains the head portion and sealing ring in the locked position by extending through flange portions of the head portion and the sealing ring.

### BRIEF DESCRIPTION OF THE DRAWINGS

FIG. 1 is a perspective view of a liquid withdrawal device affixed to a container, such as a dewar, according to various examples of the disclosure.

FIG. 2 is a perspective view of a sealing ring of the liquid withdrawal device affixed to the dewar of FIG. 1.

FIG. 3 is a top perspective view of a liquid withdrawal device, according to a further embodiment of the present disclosure.

FIG. 4 is a bottom perspective view of the liquid withdrawal device of FIG. 3.

FIG. 5 is an exploded view of the liquid withdrawal device of FIG. 3.

FIG. 6 is a top perspective view of a sealing ring useable with the liquid withdrawal device of FIG. 3.

FIG. 7 is a bottom perspective view of a sealing ring useable with the liquid withdrawal device of FIG. 3.

FIG. 8 is a perspective view of a gasket useable to form a seal among components of a liquid withdrawal device according to aspects of the present disclosure.

FIG. 9 is a perspective view of a body of head portion of the liquid withdrawal device of FIG. 3.

FIG. 10 is a top plan view of the body of the head portion of FIG. 9.

FIG. 11 is a bottom plan view of the body of the head portion of FIG. 9.

FIG. 12 is a cross-sectional view of the liquid withdrawal device illustrating engagement of a locking pin between flanges of the head portion and the sealing ring of a liquid withdrawal device as seen in FIGS. 3-5.

### DETAILED DESCRIPTION

Examples of the present disclosure relate to a liquid withdrawal device including a dewar sealing ring that is adherable around an opening of the dewar. The sealing ring is configured to ensure a substantially hermetic coupling of the dewar to a liquid transfer device to facilitate liquid transfer from the dewar via the liquid withdrawal device.

In some aspects, a liquid withdrawal device may include a sealing ring and a head portion. The sealing ring is affixed to a cryogenic storage dewar configured to hold cryogenic liquids therein, and is couplable to the head portion. The sealing ring may be epoxied or welded to the dewar, depending on the outer surface material of the dewar. The sealing ring may include an inner seal positionable against an outer surface of the dewar to form a seal against the outer surface of the dewar. The sealing ring may have raised edges at a circumference thereof, the raised edges being separated by flanges, and may also include an O-ring seal disposed on a recess along an internal perimeter thereof. The raised edges also include a projection directed towards a center of the sealing ring, and the projections together with the recess define a space therein.

The head portion of the liquid withdrawal device may be securely coupled to the dewar via the sealing ring via a twist-and-lock interface configuration. The head portion, in example embodiments, has a flanged interface configured to lock and twist in the space defined by the flanges and the projections of the sealing ring. Advantages of such a twist-and-lock configuration include a more secure attachment of the liquid withdrawal device to the dewar itself. The permanently adhered sealing ring via, e.g., an epoxy adhesive, ensures a reduction or elimination of leaks of, e.g., the cryogenic liquid from inside the dewar, and may be installed on dewars having a variety of neck and/or opening diameters and heights. Further advantages are reflected below in conjunction with the present disclosure.

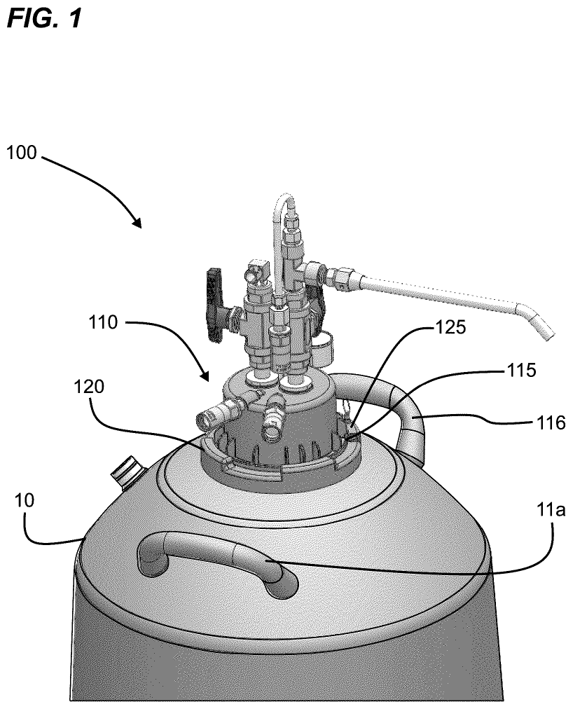

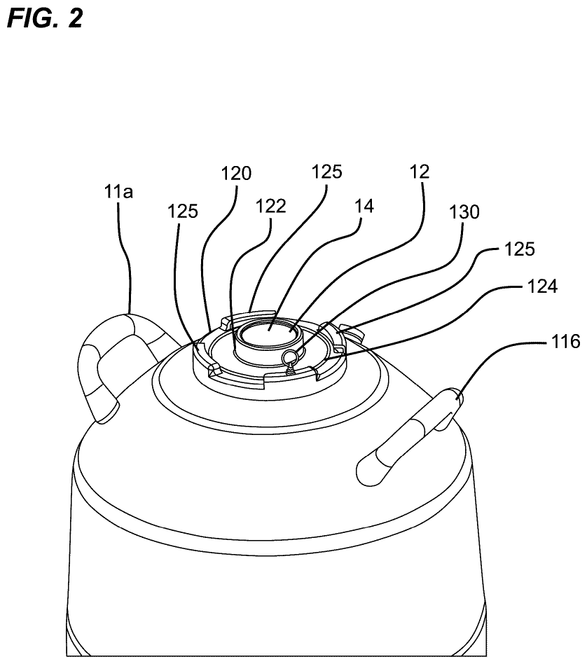

FIGS. 1-2 are a front perspective view of a liquid withdrawal device 100 mounted to a dewar 10, according to an example embodiment of the present disclosure. In the example shown, a portion of the dewar 10 is depicted, including a top portion having handles 11a-b, and a neck 12 extending to an aperture 14 (seen in FIG. 2). In examples, the liquid withdrawal device 100 includes a sealing ring 120 and a head portion 110. FIG. 1 in particular illustrates the head portion 110 mounted to the sealing ring 120, while FIG. 2 illustrates the head portion 110 removed, with the sealing ring 120 mounted around the opening 14 of the dewar 10.

The dewar 10 may be configured to hold therein a liquid at low temperature such as, e.g., a cryogenic liquid. The liquid may be maintained in a generally non-pressurized or low pressure state, in which there may be some outward pressure formed by evaporation, but a generally high pressure state is avoided. For example, in some instances, the pressure inside the dewar 10 may be in a range of as 10 psig (0.7 Bar, or 69 kPa), or up to about 20 psig (approx. 1.5 Bar or 150 kPa) while being filled.

As seen in particular in FIG. 1, and described further below, the liquid withdrawal device 100 is installed on the dewar 10 by affixing the sealing ring 120 to the dewar, for example by epoxy and/or welding. The head portion 110 may then be removably attached to the sealing ring 120 via a twist-lock configuration, described in further detail below.

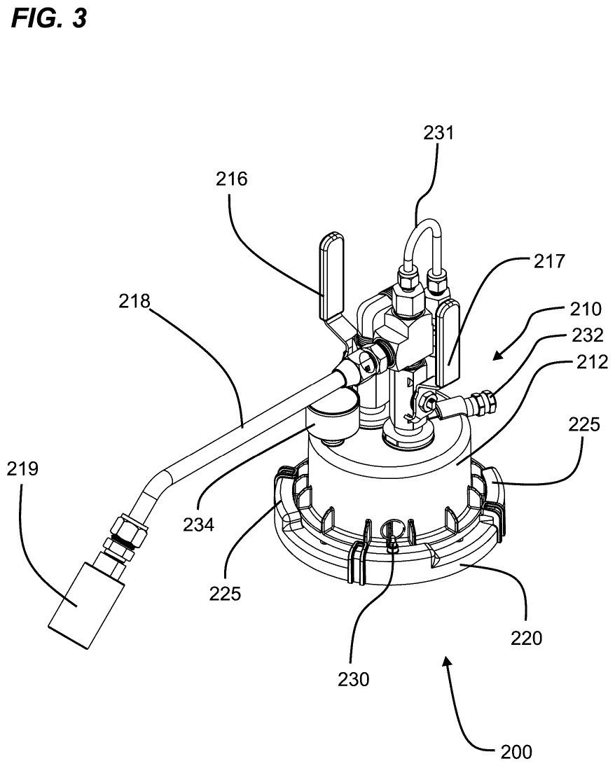

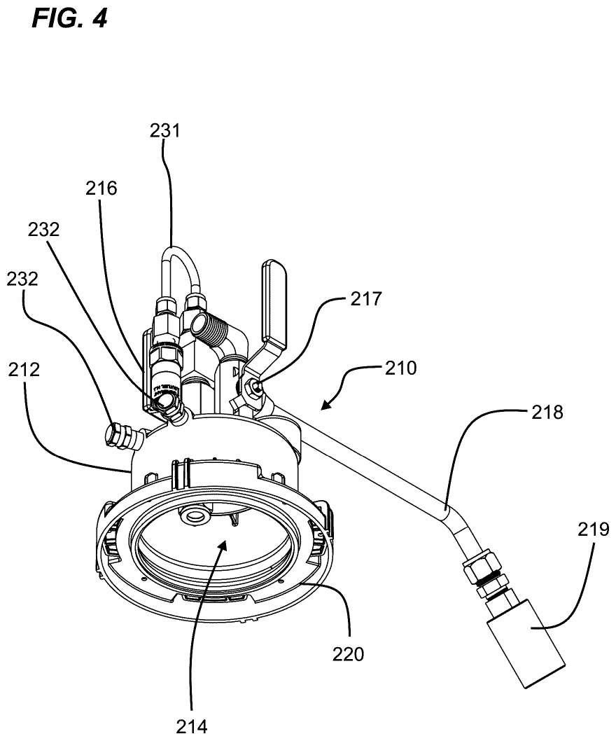

FIG. 2 illustrates the sealing ring 120 with the head portion 110 removed. The sealing ring 120 is installed around the aperture 14 of the dewar 10. In the example shown, the sealing ring 120 has a cylindrical inner wall structure 122 that is complementary in height and shape to the neck 12 and aperture 14 of the dewar 10; however, this arrangement is optional, and the sealing ring 120 may be installed without having such an inner wall structure 122 (an alternative being seen in FIGS. 3-5, below). Rather, an inner aperture of the sealing ring 120 merely needs to have a diameter greater than that of the aperture 14 and neck 12, so that the sealing ring 120 may be affixed to an outer surface of the dewar 10 around the aperture 14.

In the example shown, the sealing ring 120 has an O-ring 124 positioned within a groove on an engaging surface positioned to receive the head portion 110. A plurality of flanges 125 are positioned along an outer edge of the sealing ring 120, and cooperate with flanges 115 of the head portion 110 to form a twist-lock sealing structure between the head portion 110 and the sealing ring 120. As discussed further below, a locking pin 130 is mounted to one of the flanges 120, and is movable and biased downward, e.g., toward the engaging, or interface surface, to extend through an aperture in that flange 120, as well as a corresponding flange 115 of the head portion 110. When the locking pin 130 extends through flanges 125, 115, the locking pin prevents rotation of the head portion 110 relative to the sealing ring 120, thereby acting to affix the head portion 110 in place once installed.

FIGS. 3-12 illustrate a further example liquid withdrawal device 200, according to an example embodiment. In this example, the liquid withdrawal device 200 similarly includes a head portion 110 and a sealing ring 220. However, in this arrangement the sealing ring 220 does not include an inner wall structure similar to structure 122 of sealing ring 120. Rather, a gasket (described further below) is compressible between the head portion 210 and the sealing ring 220 and is positioned inwardly (toward the opening 14 of dewar 10) from the sealing ring 220.

In particular, FIGS. 3-5 illustrate details regarding a liquid withdrawal device 200, according to this embodiment. In the example shown, the head portion 210 includes a body 212 defining an interior portion 214, which is exposed from an underside of the body 212 and sized to be positioned over an aperture 14 of a dewar 10. The body 212 includes the plurality of flanges 215 extending radially outwardly therefrom for engaging complementary flanges 225 of the sealing ring 220.

In the example shown, the head portion 210 includes a valve assembly mounted to body 212 that includes a liquid valve 216 and a vent valve 217. A spout assembly 218 is mounted above the liquid valve 216, and includes a phase separator 219 positioned at an end thereof. The phase separator 219 allows for dispensing of gas from the dewar 10, without dispensing any liquid from within the dewar 10 or which may have condensed along a tube of the spout assembly 218. The liquid valve 216 is fluidically connected to the vent valve 217 via a relief tube structure 231, thereby allowing a return path for gas into the dewar 10 through the vent valve 217. It is noted that the head portion 110 of FIGS. 1-2 may include analogous structures, but description of those structures is omitted here for brevity.

In the example shown, the head portion 210 includes one or more pressure relief valves 232 as well as a pressure gauge 234. The pressure relief valves 232 may be adapted to open when a pressure within the interior portion 214 is above a predetermined threshold, e.g., when a difference in pressure between the interior portion 214 (which may be fluidically connected to an interior of the dewar when the head portion 210 is mounted to sealing ring 220), thereby releasing excess gas pressure buildup within the dewar.

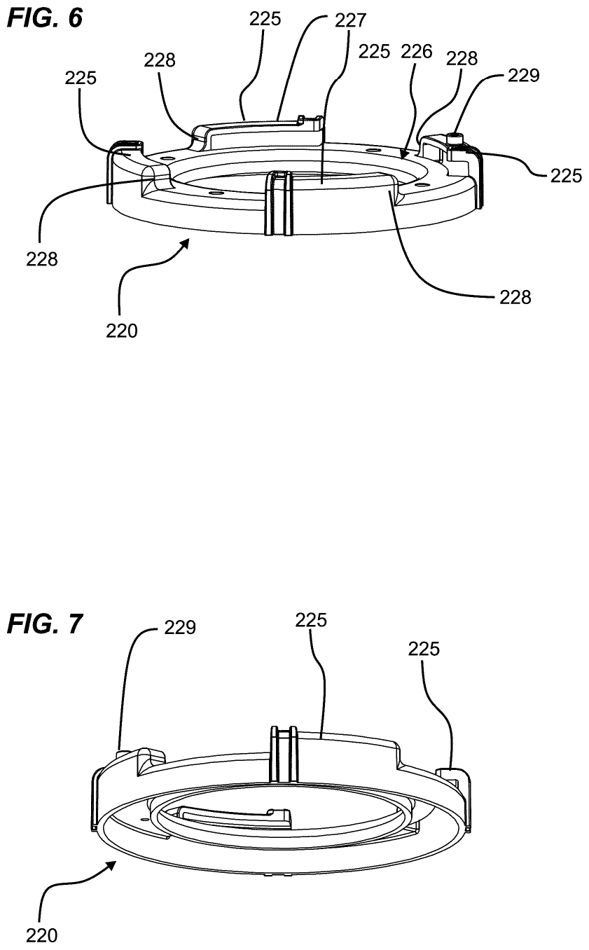

The sealing ring 220, in the embodiment shown, includes a plurality of alternating raised flanges 225, each of which extend upward (e.g., away from the underside surface to be affixed to the dewar) from an interface surface 226. As seen best in FIGS. 6-7, each of the raised flanges 225 has a top surface 227, and one closed end surface 228. Each flange 225 is therefore open toward one side and toward a central axis, forming a recess to allow the flange 225 to receive a complementary flange 215 of the head portion 210 to form the twist-lock engagement therebetween. Furthermore, at least one of the top surfaces 227 includes an aperture 229 for receiving a locking pin 230, which locks the head portion 210 in place when in a “locked” position, as discussed further below.

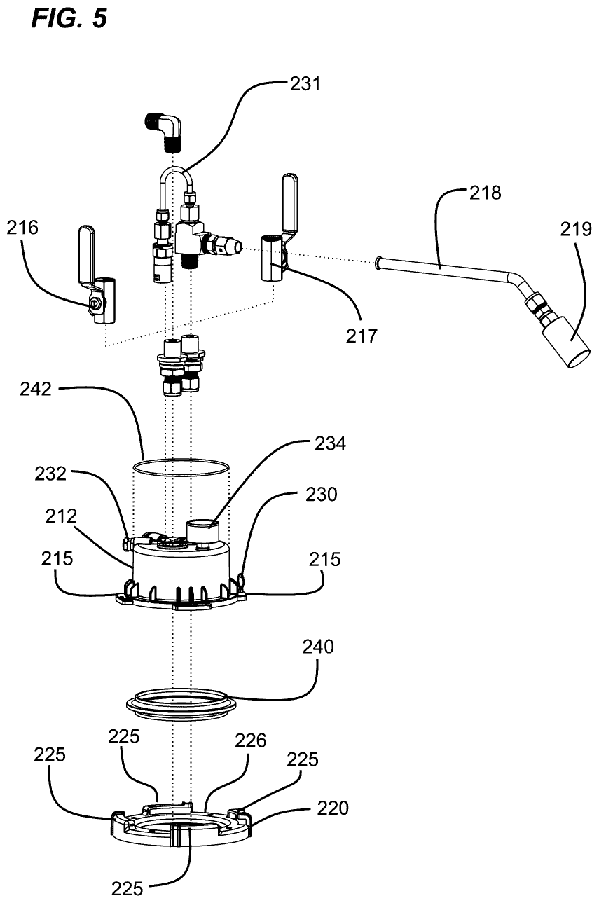

As seen in FIG. 5, in this embodiment, a sealing gasket 240 may be positioned to form a seal against both the interface surface 226 of the sealing ring 220 and an underside of the head portion 210. In examples, an O-ring 242 may be positioned within the interior portion along a lower perimeter of the body 212, and forms a seal against the sealing gasket 240. The O-ring 242 and the sealing gasket 240 may be formed of a variety of semi-resilient elastomeric materials able to form a seal between the interface surface 226 of the sealing ring 220 and the body 212 of the head portion 210.

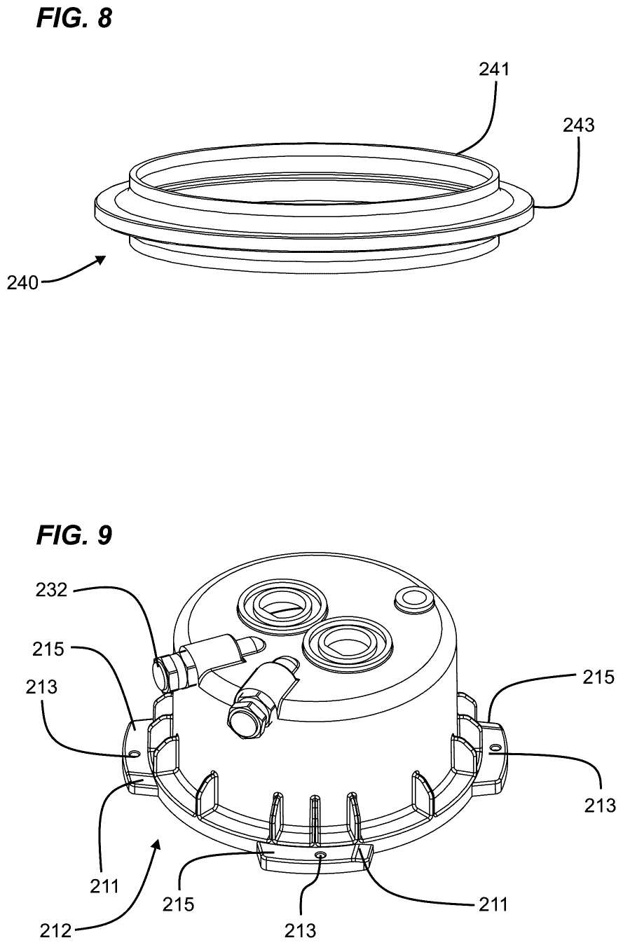

FIG. 8 illustrates the gasket 240 in further detail. The gasket 240, in the embodiment shown, has a cylindrical portion 241 and a radially extending sealing section 243. The cylindrical portion 241 has a diameter slightly smaller than an inner diameter of the sealing ring 220, and larger than a diameter of an opening 14 of the dewar 10. In examples, the cylindrical portion 241 has a height from a lower portion to the sealing section 243 such that it may contact an outer surface of the dewar 10 (i.e., the height of a lower portion of the cylindrical portion 241, up to the sealing section, is similar to or the same as a height of the sealing ring 220 from its lowermost portion at which it is affixed to a dewar up to the interface surface 226. The cylindrical portion 241 of gasket 240 may extend upwards into the body 212 to retain the O-ring 242 in place when installed in the sealing arrangement. That is, the gasket 240 and O-ring 242 cooperate to form a seal between the interface surface 226 and the body 212, and in some instances, the gasket may further provides a seal against an outer surface of the dewar 10 to which the sealing ring 220 is affixed, so as to ensure a snug and substantially hermetic fit between the dewar 10, the sealing ring 220 and, e.g., a head portion 210 of a liquid withdrawal device.

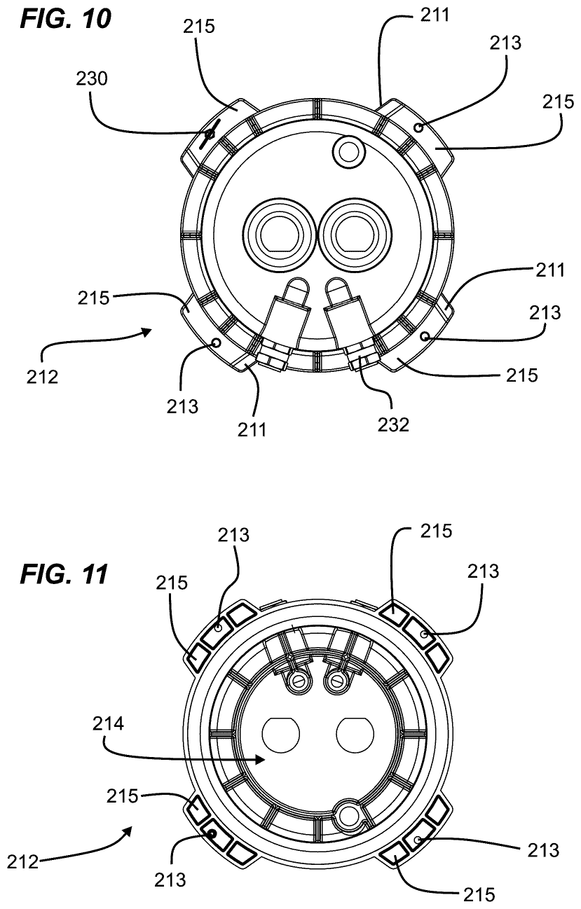

FIGS. 9-11 illustrate the body 212 in further detail. Generally speaking, the body 212 includes flanges 215 extending from a base portion, each of which includes an aperture 213 therethrough. Each aperture is positioned such that, when the body is positioned in the “locked” position and engaged with the sealing ring 220 (e.g., as seen in FIG. 3), at least one aperture is aligned with the aperture 229 such that locking pin 230 (seen in FIG. 10) may extend through both apertures 229, 213, to prevent inadvertent rotation of the head portion 210. The body 212 may also include molded portions for receiving pressure relief valves 232, and top apertures for receiving the pressure gauge 234 as well as conduits forming the liquid withdrawal circuit that lead through the liquid valve 216 and vent valve 217.

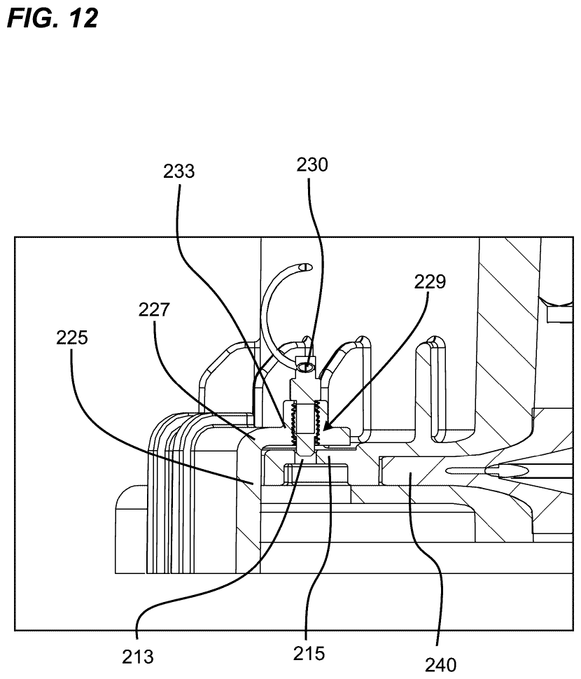

FIG. 12 illustrates a cross-sectional view of a portion of the liquid withdrawal device 200 in the “locked” position of the twist-and-lock configuration. In this view, the cross-section is taken through a portion of the liquid withdrawal device that intersects the locking pin 230.

As illustrated in FIG. 12, the locking pin 230 is spring biased downwardly toward the interface surface 226 via a spring maintained within the aperture 229. The locking pin may include a spring 233 to bias the locking pin downward toward interface surface 226; however, in other examples other biasing arrangements may be used.

In some instances, and as seen in FIG. 9, each of the flanges 215 may include a ramped top surface 211, which may encourage movement of the locking pin 230 upwardly as the head portion 210 is twisted into the locked position. Once in the locked position as seen in FIG. 12, an aperture 213 of one of the flanges 215 will align with the locking pin 230 and aperture 229, and the locking pin may therefore be biased into a locking configuration and extend into the aperture 213.

This disclosure described some examples of the present technology with reference to the accompanying drawings, in which only some of the possible examples were shown. Other aspects can, however, be embodied in many different forms and should not be construed as limited to the examples set forth herein. Rather, these examples were provided so that this disclosure was thorough and complete and fully conveyed the scope of the possible examples to those skilled in the art.

Although specific examples were described herein, the scope of the technology is not limited to those specific examples. One skilled in the art will recognize other examples or improvements that are within the scope of the present technology. Therefore, the specific structure, acts, or media are disclosed only as illustrative examples. Examples according to the technology may also combine elements or components of those that are disclosed in general but not expressly exemplified in combination, unless otherwise stated herein. The scope of the technology is defined by the following claims and any equivalents therein.

1. A sealing ring for use in a liquid withdrawal device, the sealing ring comprising:
a ring-shaped body forming an interface surface;
a plurality of alternating flanges positioned along an outer perimeter of the sealing ring and extending upwardly from the interface surface, each of the plurality of alternating flanges including:
an outer edge portion extending upwardly from an outer perimeter of the body;
a top surface extending axially inwardly from the outer edge portion above the interface surface; and
an end wall along one side of the top flange extending from the top flange to the interface surface, thereby forming a flange-receiving recess.

2. The sealing ring of claim 1, further comprising:
an aperture extending through the top surface of at least one of the plurality of alternating flanges; and
a locking pin extending through the aperture and biased toward the interface surface.

3. The sealing ring of claim 1, wherein the outer perimeter defines a circular shape.

4. The sealing ring of claim 1, further comprising an O-ring seal arranged along the circular recess.

5. The sealing ring of claim 1, further comprising a gasket positioned inward of the interface surface and having a flange positioned at least partially above the interface surface.

6. A liquid withdrawal device comprising:
a sealing ring comprising:
a ring-shaped body forming an interface surface;
a plurality of alternating flanges positioned along an outer perimeter of the sealing ring and extending upwardly from the interface surface, each of the plurality of alternating flanges including:
an outer edge portion extending upwardly from an outer perimeter of the body;
a top surface extending axially inwardly from the outer edge portion above the interface surface; and
an end wall along one side of the top flange extending from the top flange to the interface surface, thereby forming a flange-receiving recess;
a head portion comprising:
a body including a plurality of flanges extending axially from a bottom portion thereof;
one or more valves; and
a spout assembly;
wherein the head portion and the sealing ring are interconnectable via a twist-and-lock interface.

7. The liquid withdrawal device of claim 6, further comprising:
an aperture through at least one of the plurality of alternating flanges;
a locking pin biased toward the interface surface and extending through the aperture; and
an aperture through one or more of the plurality of flanges extending axially from the body of the head portion.

8. The liquid withdrawal device of claim 7, wherein the plurality of flanges extending axially from the body of the head portion each include a ramped portion.

9. The liquid withdrawal device of claim 6, wherein the head portion includes a pressure gauge, wherein the one or more valves includes a pressure relief valve.

10. The liquid withdrawal device of claim 6, wherein the one or more valves includes a liquid valve and a vent valve.

11. The liquid withdrawal device of claim 10, wherein the liquid valve is fluidically connected to the vent valve, and the spout assembly is fluidically connected proximate the liquid valve.

12. The liquid withdrawal device of claim 6, wherein the spout assembly includes a phase separator.

13. The liquid withdrawal device of claim 6, further comprising a gasket positioned inward of the interface surface and having a flange positioned at least partially above the interface surface.

14. The liquid withdrawal device of claim 13, wherein the flange forms a seal between the interface surface of the sealing ring and the body of the head portion when the head portion and the sealing ring are interconnected at the twist-and-lock interface in a locked position.

15. A liquid withdrawal system comprising:
a sealing ring affixed to a dewar around a mouth of the dewar including a plurality of flanges forming recesses above an interface surface, the flanges and interface surface forming a twist-and-lock interface;
a head portion including a body, a plurality of valves, and a spout assembly, the head portion including a plurality of flanges complementary to the recesses formed by the plurality of flanges of the sealing ring.

16. The liquid withdrawal system of claim 15, wherein the sealing ring is adhered to the dewar via an epoxy adhesive.

17. The liquid withdrawal system of claim 15, wherein the sealing ring is adhered to the dewar via welding.

18. The liquid withdrawal system of claim 15, further comprising the dewar, wherein the dewar is configured to contain a cryogenic liquid.

19. The liquid withdrawal system of claim 15, wherein:
the sealing ring comprises a ring-shaped body forming an interface surface;
the plurality of flanges are positioned along an outer perimeter of the sealing ring and extending upwardly from the interface surface, each of the plurality of alternating flanges including:
an outer edge portion extending upwardly from an outer perimeter of the body;
a top surface extending axially inwardly from the outer edge portion above the interface surface; and
an end wall along one side of the top flange extending from the top flange to the interface surface, thereby forming a flange-receiving recess.

20. The liquid withdrawal system of claim 15, further comprising a locking pin extending through an aperture in at least one of the plurality of flanges of the sealing ring and a flange of the plurality of flanges of the head portion, thereby retaining relative positions of the sealing ring and the head portion in a locked position via the twist-and-lock interface.
